(19) United States
(12) Patent Application Publication
(10) Pub. No.: US 2010/0095035 A1
(43) Pub. Date: Apr. 15, 2010

(54) POLYHEDRAL ASSEMBLY, MASTER-SLAVE BASED ELECTRONIC SYSTEM USING THE SAME AND ADDRESSING METHOD THEREOF

(75) Inventors: Jen-Feng Chen, Taichung City (TW); Jung-Chen Hung, Hsinchu City (TW); Shu-Fen Ke, Taipei City (TW); Yi-Yaun Chen, Taipei City (TW); Jiung-Cheng Pan, Taipei City (TW); Wen-Ming Wu, Taipei City (TW); Ying Lilin, Taipei County (TW); Chih-Jia Chen, Taipei County (TW)

Correspondence Address: COVENANT IP CONSULTING CO., P.O. BOX 34-306 TAIPEI CITY, TAIPEI, 10499, TW

(73) Assignee: QISDA CORPORATION, Taoyuan Shien (TW)

(21) Appl. No.: 12/576,347

(22) Filed: Oct. 9, 2009

(30) Foreign Application Priority Data
Oct. 9, 2008 (TW) 97138950
Feb. 13, 2009 (TW) 98104812

(51) Int. Cl. G06F 13/00

(52) U.S. Cl. 710/110

(57) ABSTRACT

A polyhedral is provided. The surface of the polyhedral is formed by connection of a plane having a plurality of hexagons and a plane having a plurality of quadrilaterals. There are six hexagonal connected to form a ring covering the surface of the polyhedral. On the surface of the polyhedral, any two connected hexagons form a contained angle of 120 degrees. The polyhedral has a light source and an electric control circuit disposed therein. A plurality of polyhedron can be connected into a multi-media light assembly having a numerical display function or a clock function.

This application claims the benefit of Taiwan applications Serial No. 97138950, filed Oct. 9, 2008 and Serial No. 98104812, filed Feb. 13, 2009 the subject matter of which is incorporated herein by reference.

### FIELD

The invention relates in general to a polyhedron assembly and a master-slave electronic system using the same.

### DESCRIPTION OF THE BACKGROUND

At initial setting, the master-slave electronic system has to define address of each slave electronic device either manually or automatically, so that the address of each electronic device will not be repeated (or overlapped). The master electronic device can make command according to the address of the to-be-controlled slave electronic device. For example, in terms of the telephone system of a building, the switch board is the master electronic device, and other extensions are the slave electronic devices. The switch board needs to know the address of an individual extension so as to call the extension. Furthermore, in terms of the serial electronic decorations (such as a light assembly and so on) used in a performance or a shop, the system has a master control device serially connected to other electronic decorations. Through the master control device, the user can control operations of the slave electronic device according to the address of the electronic decorations.

Currently, if the master-slave system adopts automatic addressing, the bi-directional addressing method is the most commonly used method. However, the bi-directional addressing method results in heavy information flow and is involved with a complicated communication protocol for the master end and the slave end, hence negatively affecting the performance of the master-slave electronic system.

Thus, some embodiments of the invention provide a uni-directional addressing master-slave electronic system, which results in light information flow and involves a simple implementation method, hence improving the performance of the master-slave electronic system.

Let serial electronic decorations (such as the light assembly) be taken for example. Currently, there is a light assembly such as the LED lamp formed by combining a number of independent LED modules. Such type of LED lamp assembly is often restricted to be used in illumination and lack of flexibility in combination.

Despite there are light assemblies possessing flexibility in combination, which allows the user to form desired combination according to his/her needs, such technique is not applicable to assemble the light assemblies in any direction but only the vertical stacking, hence lacking of flexibility and versatility in combination. Furthermore, user cannot control of each bulb according to his/her needs.

Thus, other embodiments of the invention provide a polyhedron assembly, which can be formed into various structures according to the user's needs. In addition, the control methods for the electronic elements of the polyhedral device enable the assembled structure to flexibly control illumination so that the user can use the LED light assembly with greater flexibility.

### SUMMARY

One example of the invention is directed to a uni-directional master-slave electronic system, which includes a master electronic device and a plurality of slave electronic devices. The master electronic device has a plurality of output ports. The slave electronic device has an input port and a plurality of output ports. The input port of the slave electronic device is connected to any output port of the master electronic device, or connected to the output port of a slave electronic device of an upper layer via a tree network structure. When a new slave electronic device is connected to the system, the master/slave electronic device of the previous layer calculates an address of this new slave electronic device and further transmits the address of the new slave electronic device to the new slave electronic device of the next layer according to the address of the master/slave electronic device and the port code of the output port.

Another example of the invention is directed to an addressing method, when a new slave electronic device is added, according to the address and the port code of the output port transmitted from the master/slave electronic device of the previous layer, the address calculating unit inside the new slave electronic device calculates the address of the new slave electronic device. Transmission of data of the master/slave electronic device of the previous layer can be periodic, or is triggered when a new slave electronic device is added to the system. After addressing of the new slave electronic device is ready, the address of the new slave electronic device is reported to the master electronic device according to actual needs.

Still another example of the present invention provides a polyhedron. The polyhedron includes six identical hexagons interconnected two by two to form a ring, the ring covering the surface of the polyhedron and surrounding a center of the polyhedron. A first hexagon disposed on the ring has a first connection port for connecting a first polyhedron.

Yet another of the present invention provides a polyhedron. The polyhedron includes a plurality of hexagons set on a surface of the polyhedron, wherein any two connected hexagons form a contained angle of 120 degrees.

Still yet another of the present invention provides a master-slave electronic system including a master electronic device and a first slave electronic device. The master electronic device includes a first output port, a master address and a first port code related to the first output port. The first slave electronic device includes a first input port and a first address calculating unit. The first input port coupled to the first output port for receiving the master address of the master electronic device and the first port code from the first output port. The first address calculating unit calculates a first slave address according to the master address and the first port code, the first slave address being as the address of the first slave electronic device.

Yet another of the present invention provides a master-slave electronic system including a master electronic device and a first slave electronic device. The master electronic device includes a master address, a first output port and a first port code related to the first output port. The master electronic device calculates a first slave address according to the master address and the first port code. The first slave electronic device includes a first input port and a first processing unit. The first input port is coupled to the first output port and receives the first slave address from the first output port. The first processing unit sets the first slave address as the address of the first slave electronic device.

It is to be understood that both the foregoing general description and the following detailed description are exemplary and explanatory only and are not restrictive of the disclosed embodiments, as claimed.

### BRIEF DESCRIPTION OF THE DRAWINGS

FIGS. 1A-1C show polyhedron assembly diagrams of the first embodiment of the invention;

FIG. 2A and FIG. 2B show external structural diagrams of a polyhedron of the first embodiment of the invention;

FIG. 3 and FIG. 4 show assembly diagrams of several polyhedrons of the first embodiment of the invention;

FIG. 5A and FIG. 5B show applications of assembly electronic elements of the first embodiment of the invention;

FIG. 6 shows assemble of several polyhedrons into a clock according to the first embodiment of the invention;

FIG. 7 shows another polyhedron external structure of the first embodiment of the invention;

FIG. 8A and FIG. 8B respectively show a polyhedron assembly diagram and a polyhedron explosion diagram of the first embodiment of the invention;

FIG. 9A and FIG. 9B show external structural diagrams of a polyhedron of the first embodiment of the invention;

FIG. 10 shows a network hardware structure of an master-slave electronic system according to the second embodiment of the invention;

FIG. 11 shows a functional block diagram of a master electronic device according to the second embodiment of the invention;

FIG. 12 shows a functional block diagram of a slave electronic device according to the second embodiment of the invention;

FIG. 13 shows an addressing diagram of the master-slave electronic system according to the second embodiment of the invention;

FIG. 14A shows a first addressing method according to the second embodiment of the invention;

FIG. 14B shows a second addressing method according to the second embodiment of the invention;

FIG. 15 shows an addressing diagram of an master-slave electronic system according to the third embodiment of the invention;

FIG. 16A shows a first addressing method according to the third embodiment of the invention; and

FIG. 16B shows a second addressing method according to the third embodiment of the invention.

### DETAILED DESCRIPTION OF THE INVENTION

### First Embodiment

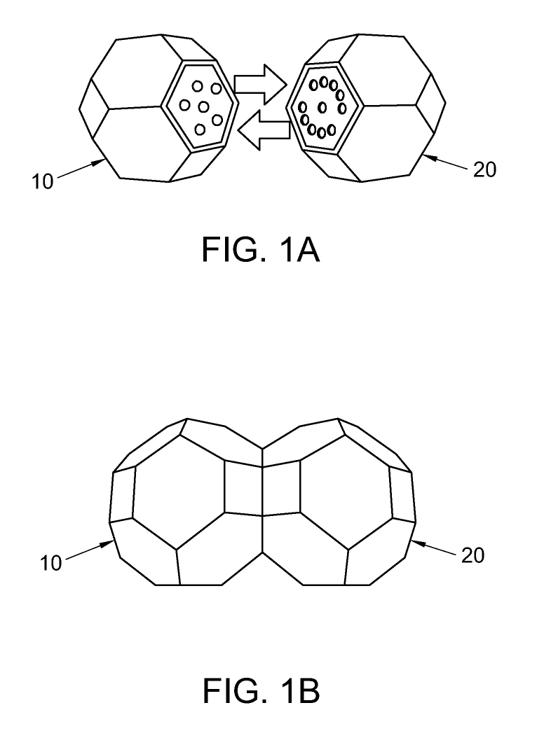

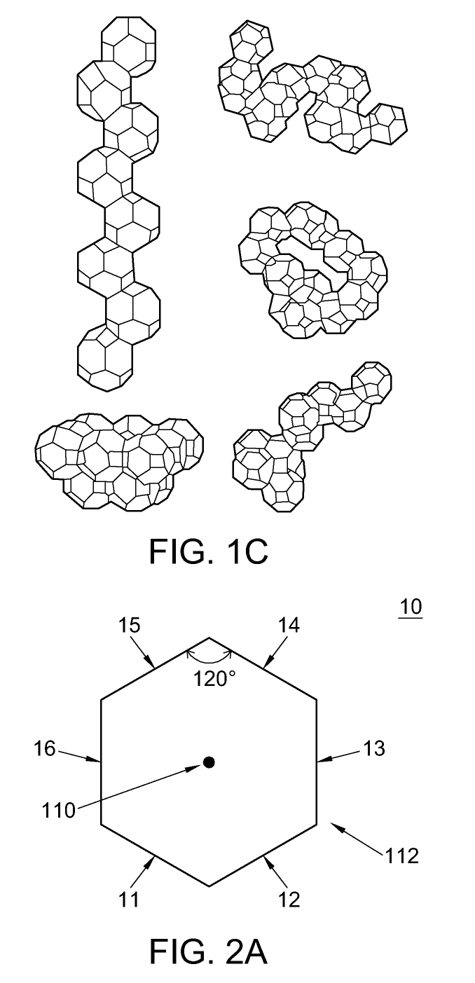

In the first embodiment of the invention, the polyhedral surface structure is improved, and electronic elements are disposed therein for performing light and sound functions etc. Referring to FIG. 1A and FIG. 1B, the polyhedron 10 and the polyhedron 20 are disclosed according to the first embodiment of the invention, and each has a connection surface. The connection surface has an electronic terminal thereon, and devices such as LED lamps, speakers or other multimedia elements may be additionally disposed inside the polyhedron. The casing of the polyhedron may be transparent or semi-transparent. When the polyhedron 10 is connected to the polyhedron 20 through their connection surfaces, the electronic terminals can be correspondingly connected. For example, the polyhedron 10 is a master control device, and the polyhedron 20 is a slave control device. Besides supply of power, the electronic terminal of the connection surface further enables the transmission of the control signal. For example, the polyhedron 10 can transmit a control signal to the polyhedron 20 to control the polyhedron 20 to perform LED lamp or speak function, multimedia functions. FIG. 1A and FIG. 1B disclose two polyhedron connection types. According to the polyhedral surface structure disclosed in the first or other embodiments of the invention, a plurality of polyhedrons are connected into a specific shape or a solid polyhedron assembly as indicated in FIG. 1C. Examples of the polyhedron connection may be made for example via a magnet disposed within the connection surface, an engaging mechanism disposed on the surface or combination thereof.

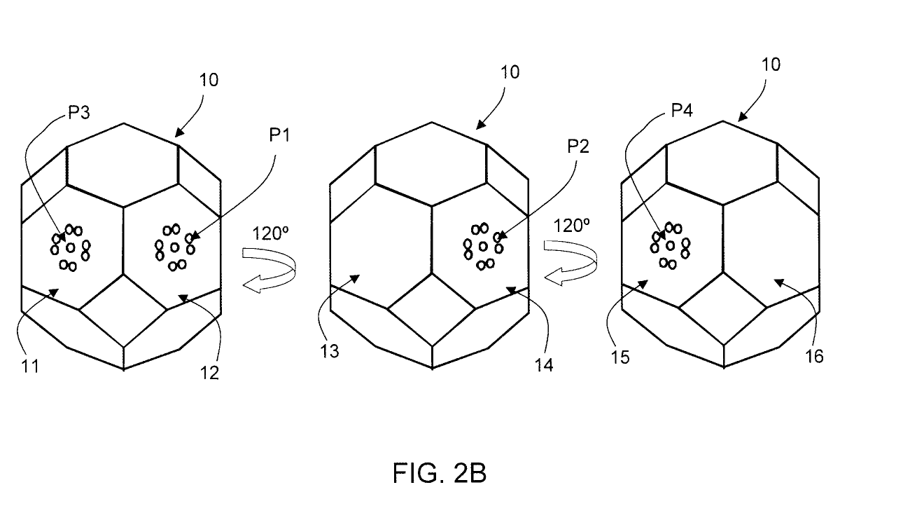

FIG. 2A shows a cross-sectional top view of the polyhedron 10 of the first embodiment of the invention. As indicated in FIG. 2A, in the polyhedron 10, six connected hexagons 11˜16 are surrounded to form a ring 112 covering a center 110 of the polyhedron 10. FIG. 2B shows a front view of the polyhedron 10 according to the first embodiment of the invention. In FIG. 2B, the two sub-diagrams at the right-hand side are the front views obtained aby rotating the polyhedron 10 for 120° and 240° respectively. The polyhedron 10 includes six hexagons 11˜16, which connect two by two to form the ring 112 which covers the surface of the polyhedron 10. In the present embodiment, the polyhedron 10 has four connection ports P1˜P4 disposed on the hexagons 12, 14, 11 and 15, respectively. However, the number of the connection ports and the planes of the polyhedron 10 on which the connection ports are disposed are determined according to actual needs. In the present embodiment of the invention, the first hexagon 12 disposed on the ring 112 has a first connection port P1, the second hexagons 14 disposed on the ring 112 has a second connection port P2, wherein the first hexagon 12 and the second hexagon 14 are separated by the third hexagon 13. The fourth hexagon 11 disposed on the ring 112 is connected to the first hexagon 12 and has a third connection port P3. The fifth hexagon 15 disposed on the ring 112 is connected to the sixth hexagons 16 and has a fourth connection port P4, wherein the fourth hexagon 11 and the fifth hexagon 15 are separated by the sixth hexagon 16. The four connection ports P1˜P4 of the polyhedron 10 can be used for connecting other polyhedrons. As the four connection ports P1˜P4 are on the same ring 112, the polyhedrons connected to the four ports can be regarded as being on the same plane. If the connection ports are disposed on the surface rather than the ring 112, then the polyhedron connected to these connection ports can be regarded as not being on the same plane.

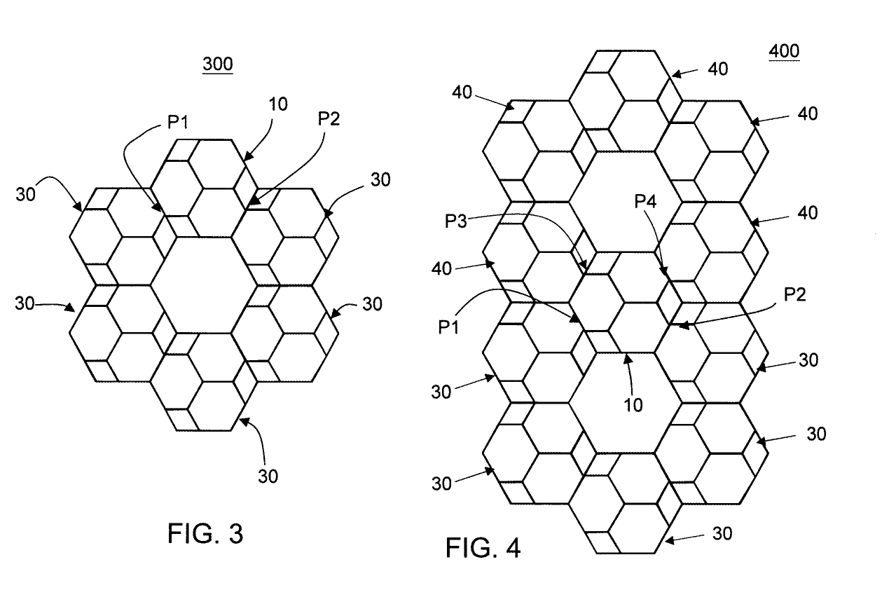

FIG. 3 and FIG. 4 show a plurality of polyhedral balls connected by the polyhedron 10, which are formed on the same plane. In FIG. 3, the polyhedron 10 and five polyhedrons 30 are connected to form a polyhedral ring 300 (or a polyhedron assembly). The appearance of the polyhedron 30 is identical to that of the polyhedron 10, wherein each polyhedron 30 has two connection ports, each disposed on one of the hexagons. The two connection ports are separated by a hexagon. On the polyhedral ring 300, the first connection port P1 and the second connection port P2 of the polyhedron 10 are connected to two neighboring polyhedrons 30, which are connected through two connection ports. As indicated in FIG. 4, the polyhedron 10 can be connected to five polyhedrons 40 two by two through a third connection port P3 and a fourth connection port P4 to form another polyhedral ring.

As indicated in FIG. 4, the polyhedron assembly 400 has a polyhedron 10, five polyhedrons 30 and five polyhedrons 40, wherein the polyhedron 10, the five polyhedrons 30 and the five polyhedrons 40 are interconnected to form an 8-shaped structure. A light source (such as an LED lamp) can be disposed inside the polyhedron to provide illumination. The casing of the polyhedron can be transparent. The illumination function of each polyhedron can be selectively turned on/off and digits 0-9 can be displayed on the 8-shaped polyhedron assembly.

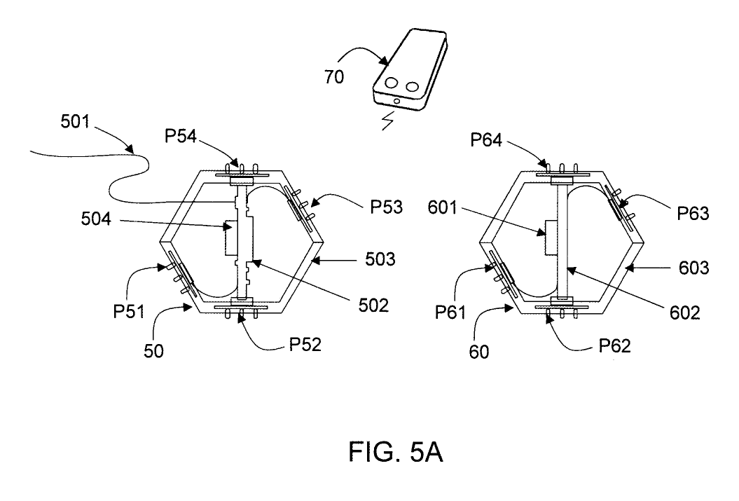

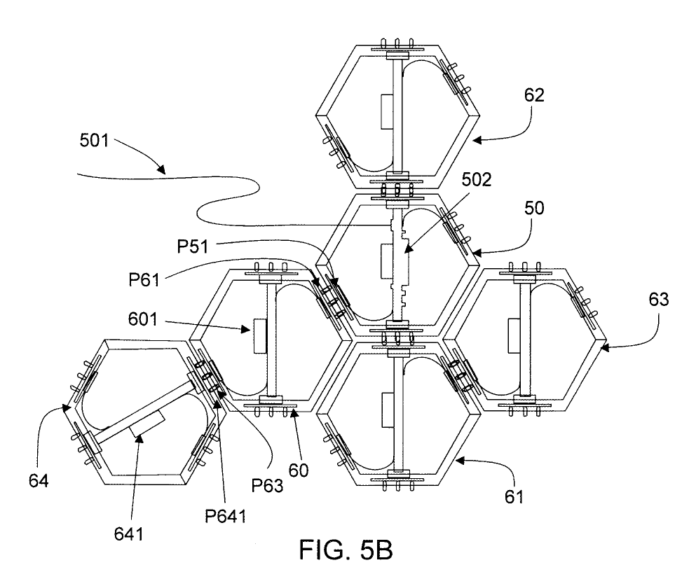

FIG. 5A shows an application of an electronic system using a polyhedron of the first embodiment of the invention. The electronic system includes a polyhedron 50, a polyhedron 60 and a remote control 70. The polyhedron 50, after coupled to the polyhedron 60, can be controlled by the remote control 70. The polyhedron 50 includes a casing 503, a master control circuit 502, four connection ports P51˜P54, an output device 504 and a power cable 501. The master control circuit 502 is coupled to the connection ports P51˜P54, the output device 504 and the power cable 501. In the present embodiment of the invention, the power needed by the polyhedron 50 and polyhedron 60 can be provided via the power cable 501 or by a built-in battery (not illustrated). The master control circuit 501 includes a reception module (not illustrated) for receiving a remote control signal of the remote control 70, wherein the remote control signal can be an infra-red signal or a Bluetooth signal. The remote control 70 controls the operation of the entire electronic system and provides a convenient human-machine interface to the user. The polyhedron 60 includes a casing 603, a slave control circuit 602, four connection ports P61˜P64 and an output device 601. The casings 503 and 603 can be transparent or pervious for allowing the light to be leaked out.

The master control circuit 502 controls the entire electronic system. In response to the remote control signal from the remote control 70, the master control circuit 502 generates at least one signal, which, through the connection ports P51˜P54, can be transmitted to other polyhedrons connected to the polyhedron 50. The reception module (not illustrated) can be disposed inside or outside the casing 502. The signal generated by the master control circuit 502 can control the operation of the output device 504. Examples of the output device 504 include bulb, light emitting diode (LED), speaker, display panel or servo motor. The user can control the output device 504 with the remote control 70 by way of manual control, voice control or pre-programmed programs so to provide multi-media effects. The power cable 501 provides power to the master control circuit 502 and the output device 504. In the present embodiment of the invention, the necessary power can be outputted to the next polyhedron through the connection ports P51˜P54. As indicated in FIG. 5B, the polyhedron 60 is connected to the connection port P51 of the polyhedron 50 through the connection port 61. Besides of transmission of the control signal outputted from the master control circuit 502, the connection port P53 can further provide power to the slave control circuit 602 through the connection port 61. The operation principles of the polyhedron 60 are similar to that of the polyhedron 50. The slave control circuit 602 passively receives the control signal from the master control circuit 502, so that the output device 601 is operated according to the control signal or the slave control circuit 602 transmits the control signal to the next polyhedron through the connection ports P61˜P64.

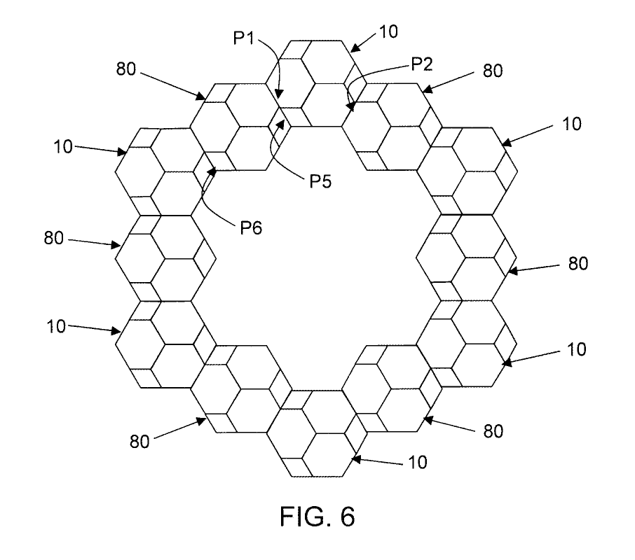

FIG. 5B shows an example of the assembly combination of the polyhedron of the first embodiment of the invention. Other connection combinations are illustrated in FIG. 1C, FIG. 3, FIG. 4 and FIG. 6. No matter what kind of connection combination, the connection combination of the polyhedron can be addressed through the addressing procedure of the master-slave electronic device. In the present embodiment of the invention, the method for addressing the polyhedrons 60, 61, 62, 63 and 64 of the polyhedron 50 is disclosed in the following embodiments. For example, if the address of the polyhedron 50 is set to be [0.0.0], the address of the polyhedron 60 is automatically set to be [1.1.0] and the address of the polyhedron 64 is set to be [2.1.1] until each polyhedron has an address. Let the operation of the output device 641 of the polyhedron 64 be taken for example. A first command generated by the master control circuit of the polyhedron 50 includes the address [2.1.1] of the polyhedron 64, wherein the first command is transmitted to the input port P61 of the polyhedron 60 through the output port P51. The slave control circuit 602 receives the address from the first command and further determines whether the received address matches from its own address. If not matched, the polyhedron 60 transmits the first command to the input port P641 of the polyhedron 64 through the output port P63 so as to operate the output device 641 of the polyhedron 64. If the output device 641 is a bulb, then the first command can control the ON/OFF of the bulb. The input port and the output port can be buses capable of transmitting power for the operation of the electronic elements inside the polyhedron.

Referring to FIG. 6, a polyhedral ring 600 formed by a plurality of polyhedrons 10 and polyhedrons 80 according to the first embodiment of the invention is shown. As indicated in FIG. 6, each polyhedron 80 has six identical hexagons connected two by two to form a first ring which covers the surface of the polyhedron 80 and surrounds the center of the polyhedron 80. The polyhedron 80 has a connection port P5 disposed on the seventh hexagons, and the sixth connection port P6 is disposed on the eighth hexagons, wherein the seventh hexagon and the eighth hexagon are disposed on the first ring and separated by two hexagons. The structure of the polyhedron 10 is indicated in FIG. 2B, wherein a plurality of polyhedrons 10 and a plurality of polyhedrons 80 are interlaced to form a polyhedral ring 600 having twelve-polyhedrons through the first connection port P1, the second connection port P2, the fifth connection port P5 and the sixth connection port P6. A plurality of polyhedrons 10 and a plurality of polyhedrons 80 have illumination function and the light function thereof may be selectively turned on/off so that the polyhedral ring 600 having twelve-polyhedrons can display time. For example, in FIG. 6, the polyhedron 10 at the top denote 12 o'clock, and the subsequent polyhedrons respectively denote 1˜11 o'clock. Also, the light emitter diodes inside the polyhedron can emit the light of different colors to carry different denotations. For example, the blue light denotes hour hand and the red light denotes minute hand.

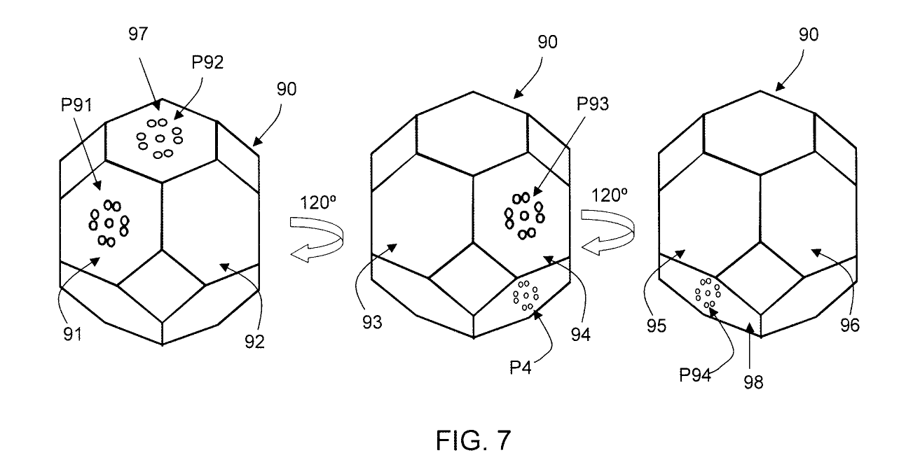

As indicated in FIG. 7, the polyhedron 90 includes six hexagons 91˜96, which are interconnected two by two to form a ring covering the surface of the polyhedron 90 and surrounding a center of the polyhedron 90. The first hexagon 91 disposed on the ring has a first connection port P91 for connecting other polyhedrons. The second hexagon 94 disposed on the ring has a connection port P93. The third hexagons 97 disposed outside the ring but on the surface of the polyhedron 90 has a third connection port P92. The third hexagons 97 and the first hexagon 91 are interconnected. At least one connected polyhedron, via the first connection port P91 and the second connection port P93, is on the first plane. At least one connected polyhedron, via the third connection port P92, is on a second plane. The second plane is not parallel to the first plane. As indicated in FIG. 7, a connection port P94 is disposed on the hexagon 98 for connecting other polyhedrons in another direction. Therefore, the polyhedron according to the first embodiment of the invention further has connection flexibility to form various combinations as indicated in FIG. 1C.

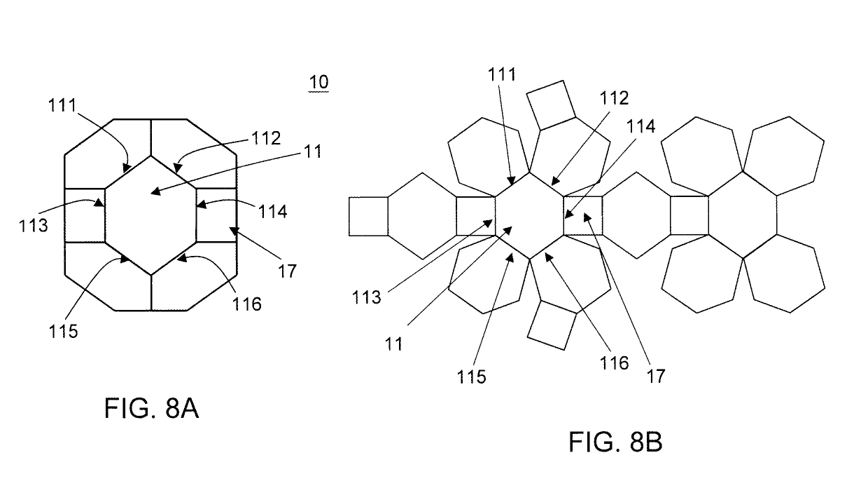

Referring to FIG. 8B, an explosion diagram of a polyhedron according to the first embodiment of the invention is shown. The outer surface of the polyhedron 10 is formed by connection of a plane having a plurality of hexagons and a plane having plurality of quadrilaterals. In the first embodiment, the appearance of the polyhedron 10 includes connection of a plane having 12 hexagons and a plane of 6 quadrilaterals. FIG. 8A is a front view of the polyhedron 10 in regard to the hexagon 11. Any of the above hexagons has four first long sides and two second long side, each second long side connected to a quadrangle and each first long side length connected to a hexagon, wherein the first long side is longer than the second long side. Let the hexagon 11 of FIG. 8A and FIG. 8B be taken for example.

The first long sides 111, 112, 115 and 116 are connected to hexagons, respectively and the second long sides 113 and 114 are respectively connected to quadrangles.

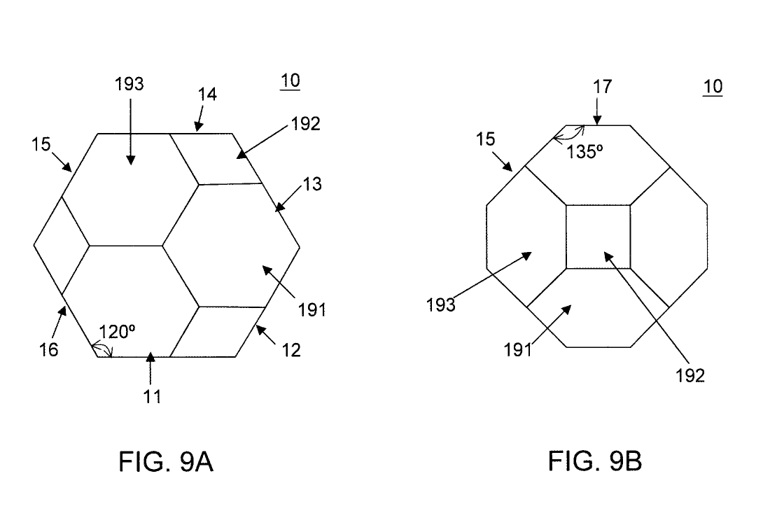

FIGS. 9A, 9B respectively show front views of the polyhedron 10 in other directions. FIGS. 9A and 9B further elaborate the features of the polyhedron of the first embodiment of the invention. FIG. 9A shows a front view of three connected hexagons. As is indicated in FIG. 9A, the sides of the polyhedron 10 are regular hexagons, and the ring 112 of FIG. 2A are formed by hexagons 11˜16. The angle contained between every two interconnected hexagons on the ring 112 is 120 degrees. FIG. 9B is a front view of the polyhedron 10 viewed in the face of the quadrangle 192. As shown from the hexagons 193 and 191 of FIGS. 9A and 9B, FIG. 9B is obtained by rotating the polyhedron 10 of FIG. 9A for an angle, and the sides of the polyhedron 10 are formed by interlacing the hexagons with the quadrangles. Because of symmetric connection, each internal angle is 135 degrees. For example, the contained angle between the hexagons 15 and the quadrangle 17 is 135 degrees.

Compared with the prior art, the first embodiment of the invention has the following advantages. Connection of the polyhedron of the first embodiment of the invention is not restricted by vertical or horizontal connection, and thus it provides a plurality of angles for the user to choose to form a desired structure. Further, by the control of the electronic elements inside the polyhedral device, the illumination function of the assembled structure can be flexibly controlled, so that the user can use the LED light assembly with greater flexibility.

A uni-directional addressing master-slave electronic system is further disclosed in other embodiments of the invention. During addressing, the address of the next slave electronic device can be calculated by from the master-slave electronic device of the previous layer to complete the addressing of the entire system. Or, the slave electronic device of the next layer calculates its own address according to the information transmitted from the master/slave electronic device of the previous layer so as to complete the addressing of the entire system.

### Second Embodiment

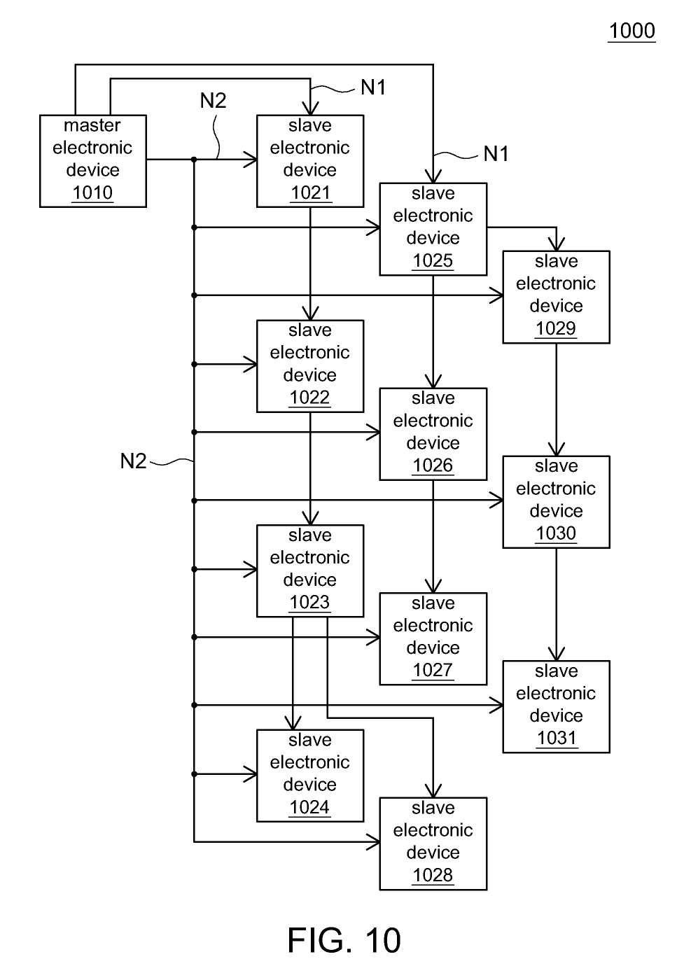

FIG. 10 shows a master-slave electronic system 1000 according to the invention the second embodiment. The master-slave electronic system 1000 includes a master electronic device 1010 and a plurality of slave electronic devices 1021˜1031. The master electronic device 1010 has a plurality of output ports connecting a plurality of digital transmission lines N1 and a digital transmission line N2. The master electronic device 1010 and the slave electronic devices 1021 and 1025 of the first layer are interconnected through the digital transmission lines N1 and N2.

Connection subsequent to the slave electronic devices 1021 and 1025 of the first layer are in a tree structure serial network. For example, the slave electronic devices 1026 and 1029 are connected to the output ports of the slave electronic device of the previous layer. That is, any slave electronic device can be directly connected to the master electronic device 1010 or indirectly connected to the master electronic device 1010 through the slave electronic device of the previous layer. In the present embodiment of the invention, through the digital transmission lines N1, all electronic devices (including the master electronic device 1010 and a plurality of slave electronic devices 1021˜1031) inside the master-slave electronic system 1000 can be addressed according to the addresses and corresponding connection port of each electronic device. After all the electronic devices inside the master-slave electronic system 1000 are addressed, the master electronic device 1010 can transmit the first command to the electronic device 1025 through the digital transmission lines N1. If the target address of the first command instructs the address of the slave electronic device 1025, then the slave electronic device 1025 executes the first command and makes corresponding response. If the target address does not indicate the address of the slave electronic device 1025, then the slave electronic device 1025 transmits the first command to the slave electronic devices 1029 and 1026 of the next layer through the output port of the slave electronic device 1025. By the same token, the operation of the slave electronic device can be obtained. Furthermore, when the command received by the slave electronic device has a predetermined universal address, the slave electronic device executes the command and transmits the received command to the slave electronic device of the next layer.

Also, the digital transmission line N2 can be optional. If the digital transmission line N2 is disposed, the master electronic device 1010 can be directly connected to all slave electronic devices 1021˜1031 through the digital transmission line N2. After all the electronic devices inside the master-slave electronic system 1000 are addressed, the master electronic device 1010 can broadcast the command (including the address signal and the data signal) to all slave electronic devices through the digital transmission lines N2. When the slave electronic device compares its own address to the received address signal and determines that its own address matches the received address signal or that the command includes a universal address signal, the slave electronic device processes the data signal and makes corresponding response. When the slave electronic device compares its own address to the address signal and determines that neither these addresses match nor the command includes a universal address signal, the slave electronic device will neglect (or ignore) the data signal. As the master electronic device 1010 transmits the command in a parallel manner, such connection will not result in non-synchronous operation between the slave electronic devices or the delay in the transmission of the command.

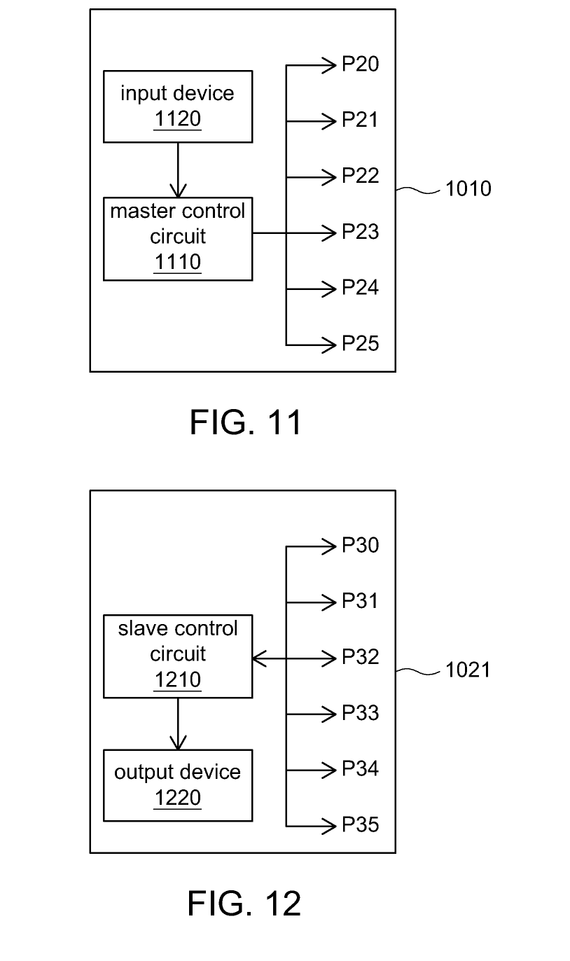

FIG. 11 shows a functional block diagram of a master electronic device according to the present embodiment of the invention. As indicated in FIG. 11, the master electronic device 1010 according to the present embodiment of the invention includes a master control circuit 1110, an input device 1120 and a plurality of connection ports P20˜P25.

The user can make or output a command through the input device 1120 such as user interface (UI), sensor, or other standard interface that can be connected to the computer device. The command made by the user is transmitted to the master control circuit 1110 through the input device 1120. After the master control circuit 1110 analyzes the user command, the corresponding command is outputted to the slave electronic device through a connection port.

The connection ports P20˜P25 can be semi-duplex connection ports, that is, connection ports P20˜P25 can be used as input port or output ports. If the master electronic device 1010 does not need to receive command from the slave electronic device, the connection ports P20˜P25 of the master electronic device 1010 can be set as output ports. In the present embodiment of the invention, each connection port is designated to a port code, that is, a port code is assigned to each connection port. For example, the port codes of the connection ports P20˜P25 respectively can be set to be 0˜5.

FIG. 12 shows a functional block diagram of a slave electronic device according to the present embodiment of the invention. The slave electronic device 1021 is used for exemplification, and other slave electronic devices basically have the same architecture. As indicated in FIG. 12, the slave electronic device 1021 according to the present embodiment of the invention includes a slave control circuit 1210, an output device 1220 and a plurality of connection ports P30˜P35. The slave control circuit 1210 can execute the function of the address calculation. The output device 1220 can be a communication terminal, a light assembly, a speaker or a vibrator.

The command transmitted by the master electronic device is selectively transmitted to the slave control circuit 1210 through the connection ports P30˜P35. After the slave control circuit 1210 analyzed the command, corresponding operations (such as making vibration or playing music) can be performed through the output device 1220. For example, when the master electronic device and the slave electronic device are both LED lamps, the corresponding operation of the slave electronic device can be the ON/OFF of the lamp.

The connection ports P30˜P35 of the slave electronic device can be semi-duplex connection port, that is, the connection ports P30˜P35 can be input ports or output ports. This is because besides receiving command from the master electronic device (under such circumstance, the connection port of the slave electronic device acts as an input port), the slave electronic device may still have to transmit relevant addressing information to the slave electronic device nearby (under such circumstance, the connection port acts as an output port). Besides, in the present embodiment of the invention, each connection port of the slave electronic device is also designated a port code. That is, a related port code is assigned to each connection port. For example, the port codes of the connection ports P30˜P35 respectively can be set to be 0˜5.

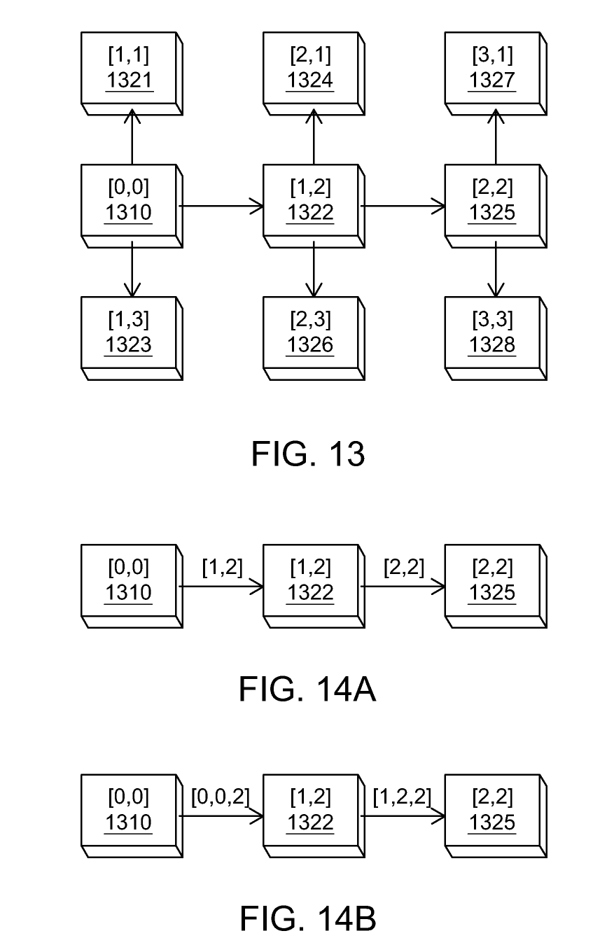

FIG. 13 shows an addressing diagram of the master-slave electronic system according to the second embodiment of the invention. As indicated in FIG. 13, the master electronic device 1310 is located in the 0-th layer; the slave electronic devices 1321˜1323 directly connected to the master electronic device 1310 are located in the first layer; the slave electronic devices 1324˜1326 connected to the master electronic device 1310 through the slave electronic devices 1321˜1323 are located in the second layer; and the slave electronic devices 1327˜1328 connected to the master electronic device 1310 through the slave electronic devices 1321˜1323, 1325 are located in the third layer.

Let the master electronic device 1310 be a reference point, and the address of the master electronic device 1310 be set to be [0, 0]. According to the addressing method of the present embodiment of the invention, the addresses of the slave electronic device 1321˜1328 are [1, 1], [1, 2], [1, 3], [2, 1], [2, 2], [2, 3], [3, 1], [3, 3], respectively, for example. The addressing is disclosed in FIG. 14A and FIG. 14B. After the user assemble of the master-slave electronic system 1000, each electronic device (the master electronic device and the slave electronic device) can identify its position relationship relative to other electronic device through the port code of the connection port. For example, the slave electronic devices 1321˜1323 identify that they are located at the top, the right and the bottom of the master electronic device 1310 respectively. The slave electronic devices 1324˜1326 are connected to the slave electronic device 1322, and identify that they are located at the top, the right and the bottom of the slave electronic device 1322 to the right of the master electronic device 1310 respectively. By the same token, all electronic devices of the system identify their own address.

FIG. 14A shows a first addressing method according to the second embodiment of the invention. After the master/slave control circuit inside the electronic device of the previous layer calculates the address of the electronic device of the next layer, the address is transmitted to the electronic device of the next layer. To the contrary, FIG. 14B shows a second addressing method according to the second embodiment of the invention. According to the information transmitted from the electronic device of the previous layer, the slave control circuit inside the electronic device of the next layer calculates its own address.

Referring to FIG. 14A. According to the first addressing method, the address of any electronic device includes a layer bit and a port address bit.

The master electronic device 1310, according to its own address [0, 0] and the port code of the connection port, calculates the address of the slave electronic device 1322 of the next layer as [1, 2]. Let the master electronic device 1310 be taken for example. The master address [0, 0] of the master electronic device 1310 includes a layer bit (the first bit whose default value is (0)) and a port address bit (the second bit whose default value is (0)). The layer bit of the address of the slave electronic device 1322 equals the layer bit (0) of the master address plus 1 (that is, 0+1=1). The port address bit of the address of the slave electronic device 1322 equals the port code of the connection port of the master electronic device 1310. Thus, according to the first addressing method of FIG. 14A, the address of the slave electronic device 1322 is [1, 2]. By the same token, the slave electronic device 1322 calculates the address of the electronic device (the slave electronic device 1325) of the next layer as [2, 2] (suppose the slave electronic device 1322 is connected to the slave electronic device 1325 through the connection port whose port code is 2).

Referring to FIG. 14B. According to the second addressing method, the address of any electronic device also includes a layer bit and a port address bit. The information that the master electronic device 1310 transmits to the slave electronic device 1322 (in the next layer) includes a (master) address of the master electronic device 1310 and a port code of the connection port. Let the (master) address of the master electronic device 1310 be [0, 0] and the port code of the connection port be 2. Thus, the information that the master electronic device 1310 transmits to the slave electronic device 1322 is [0, 0, 2]. After the slave electronic device 1322 receives [0, 0, 2], the slave electronic device 1322 calculates its own address (including a layer bit and a port address bit). The layer bit of the address of the slave electronic device 1322 equals the (master) layer bit (0) of the master address plus 1, that is, 0+1=1. The port address bit of the address of the slave electronic device 1322 is the port code of the connection port of the master electronic device 1310. Thus, according to the addressing method of FIG. 5B, the address of the slave electronic device 1322 is [1, 2]. By the same token, the information that the slave electronic device 1322 transmits to the slave electronic device 1325 is [1, 2, 2]. Based on the information, the slave electronic device 1325 calculates its own address as [2, 2].

After the master electronic device and all slave electronic devices are initialized, the addressing of the master electronic device and the slave electronic device can be done by the same token. When the addressing of the master electronic device and all the slave electronic devices in the system is done or the amount of valid addresses in the system reaches an upper limit, the master electronic device starts to control the slave electronic device. The master electronic device transmits the command including an address signal and a data signal to the slave electronic device.

### Third Embodiment

The third embodiment of the invention differs with the second embodiment in the address format and the addressing method.

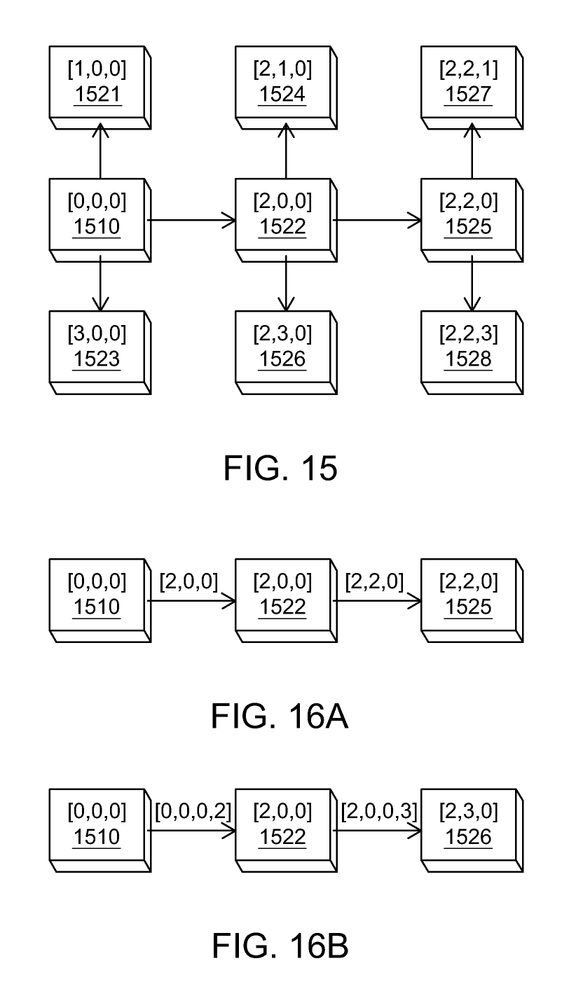

FIG. 15 shows an addressing diagram of a master-slave electronic system according to the third embodiment of the invention. The designation 1510 denotes a master electronic device and the designations 1521˜1528 denote eight slave electronic devices. The layer number of the third embodiment is the same as that of the second embodiment, and the details are omitted here. In the present embodiment, the layer number is exemplified by 3, so the address includes 3 bits. If the master-slave electronic system has n layers (n is a positive integer), then the address includes n bits.

Two addressing methods are disclosed in the third embodiment. FIG. 16A shows a first addressing method according to the third embodiment of the invention. FIG. 16B shows a second addressing method according to the third embodiment of the invention.

In FIG. 16A, after the electronic device of the previous layer calculates the address of the electronic device of the next layer, the calculated address is transmitted to the electronic device of the next layer. To the contrary, in FIG. 16B, the electronic device of the next layer calculates its own address according to the information transmitted from the electronic device of the previous layer.

Referring to FIG. 16A. The master electronic device 1510, according to its own address [0, 0, 0] and the port code (2) of the connection port, calculates the address of the slave electronic device 1522 of the next layer as [2, 0, 0]. The calculation is disclosed below. The master electronic device 1510 fills the port code of the connection port into the first 0-valued bit (i.e. the first bit in this case) from MSB of the master address to form the address of the slave electronic device 1522. So, the master electronic device 1510 calculates the address of the slave electronic device 1522 as [2, 0, 0]. By the same token, the slave electronic device 1522 calculates the address of the slave electronic device 1525 as [2, 2, 0].

Referring to FIG. 16B. The information that the master electronic device 1510 transmits to the slave electronic device 1522 includes a (master) address of the master electronic device 1510 and a port code of the connection port. Let the master address of the master electronic device 1510 be [0,0,0] and the port code of the connection port be 2. Thus, the information that the master electronic device 1510 transmits to the slave electronic device 1522 is [0, 0, 0, 2], wherein, the port code is placed at the last bit. After the slave electronic device 1522 receives [0, 0, 0, 2], the slave electronic device 1522 identifies the port code and fills it into the first 0-valued bit (the first bit) from MSB of the master address to form the address of the slave electronic device 1522. Thus, the slave electronic device 1522 calculates its own address as [2, 0, 0].

By the same token, let the slave electronic device 1522 be connected to the slave electronic device 1526 through the connection port whose port code is 3. Thus, the information that the slave electronic device 1522 transmits to the slave electronic device 1526 is [2,0,0,3], wherein, the port code (3) is placed at the last bit. After the slave electronic device 1526 receives [2,0,0,3], the slave electronic device 626 identifies the port code (3) and fills it to the first 0-valued bit (the second bit) counted from MSB of [2, 0, 0] (the address of the slave electronic device 1522) to form the address [2, 3, 0] of the slave electronic device 626.

According to the addressing method of FIG. 16A or FIG. 16B, in FIG. 15, the address of the master electronic device 1510 is [0, 0, 0], and the addresses of the slave electronic devices 1521˜1528 are [1, 0, 0], [2, 0, 0], [3, 0, 0], [2, 1, 0], [2, 2, 0], [2, 3, 0], [2, 2, 1] and [2, 2, 3], respectively.

According to the second and the third embodiment of the invention, the slave electronic device acts as an independent installation module. If the master-slave electronic system is a telephone system inside a building, the address of each extension can be quickly addressed and each extension is controlled by the switch board if the extensions are addressed by way of the above embodiments according to the invention. Or, if the master-slave electronic system is a lamp system installed in a performance, the light assembly modules can be installed by way of serial connection according to the designer's needs and further addressed automatically by way of the above embodiments according to the invention, so that the lamp system is controlled through the master station.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. A polyhedron, comprising:
six identical hexagons interconnected two by two to form a ring, the ring covering a surface of the polyhedron and surrounding a center of the polyhedron, wherein a first hexagon of the ring has a first connection port for connecting a first polyhedron.

2. The polyhedron according to claim 1, wherein a second hexagon of the ring has a second connection port and the first hexagon and the second hexagon are separated by a third hexagon.

3. The polyhedron according to claim 2, wherein, the first polyhedron and the polyhedron are the same, the polyhedron and five of the first polyhedrons are interconnected two by two and are further connected through the first connection port and the second connection port to form a first polyhedral ring.

4. The polyhedron according to claim 3, wherein a fourth hexagon of the ring is connected to the first hexagon and has a third connection port, a fifth hexagon of the ring is connected to the second hexagons and has a fourth connection port, the fourth hexagon and the fifth hexagon are separated by a sixth hexagon, the polyhedron and another five of the first polyhedrons are interconnected two by two and are further connected through the third connection port and the fourth connection port to form a second polyhedral ring.

5. The polyhedron according to claim 4, wherein, the polyhedron and the ten of the first polyhedrons each has an illumination function for selectively turning on and off, so that the first polyhedral ring and the second polyhedral ring selectively displaying digits 0˜9.

6. The polyhedron according to claim 2, wherein, the first polyhedron has six identical hexagons which are interconnected two by two to form a first ring which covers a surface of the first polyhedron and surrounds a center of the first polyhedron, the first polyhedron has a fifth connection port disposed on a seventh hexagon and a sixth connection port disposed on an eighth hexagon, the seventh hexagon and the eighth hexagon are disposed on the first ring and are separated by two hexagons, wherein a plurality of the polyhedrons and a plurality of the first polyhedrons are interlaced and are further connected through the connection ports to form a polyhedron ring having twelve polyhedrons, wherein, a plurality of the polyhedrons and a plurality of the first polyhedrons each has an illumination function for selectively turning on and off, so that the polyhedron ring having twelve polyhedrons displays a time information.

7. The polyhedron according to claim 1, wherein, any of the hexagons on the polyhedron has four long sides and two short sides, any of the short sides is connected to a respective quadrangle and any of the long sides is connected to a respective hexagon.

8. The polyhedron according to claim 1, wherein the surface of the polyhedron is formed by connection of 12 hexagons and 6 quadrilaterals.

9. The polyhedron according to claim 1, further comprising:
a master control circuit disposed inside the polyhedron, wherein the master control circuit is electrically coupled to the first connection port for transmitting a first signal to the first connection port; and
a first lighting element for selectively turning on and off according to a second signal from the master control circuit.

10. The polyhedron according to claim 9, wherein the first polyhedron comprises:
an input port coupled to the first connection port;
a slave control circuit disposed inside the first polyhedron, wherein the slave control circuit is electrically coupled to the input port for receiving the first signal; and
a second lighting element for selectively turning on and off according to the first signal.

11. The polyhedron according to claim 10, the first polyhedron further comprising:
an output port coupled to the slave control circuit, wherein, when the master control circuit outputs a third signal to the slave control circuit, the slave control circuit compares the third signal to a first address of the slave control circuit, and if not matched, the slave control circuit outputs the third signal from the output port.

12. A polyhedron, comprising:
a plurality of hexagons set on a surface of the polyhedron, wherein any two connected hexagons form a contained angle of 120 degrees.

13. The polyhedron according to claim 12, wherein the hexagons are interconnected two by two to form a ring which covers a center of the polyhedron, and a first hexagon on the ring has a first connection port for connecting a first polyhedron.

14. The polyhedron according to claim 13, further comprising:
a master control circuit disposed inside the polyhedron, wherein the master control circuit is electrically coupled to the first connection port for transmitting a first signal to the first connection port; and
a first lighting element for selectively turning on and off according to a second signal from the master control circuit.

15. The polyhedron according to claim 14, wherein, the first polyhedron comprises:
an input port coupled to the first connection port;
a slave control circuit disposed inside the first polyhedron, wherein the slave control circuit is electrically coupled to the input port for receiving the first signal; and
a second lighting element, selectively turned on/off according to the first signal.

16. A master-slave electronic system, comprising:
a master electronic device, comprising a first output port, a master address and a first port code related to the first output port; and
a first slave electronic device, comprising:
a first input port coupled to the first output port for receiving the master address of the master electronic device and the first port code from the first output port; and
a first address calculating unit, calculating a first slave address according to the master address and the first port code for determining the first slave address as an address of the first slave electronic device.

17. The master-slave electronic system according to claim 16, wherein, the first slave electronic device further comprises a second output port and a second port code related to the second output port, the master-slave electronic system further comprises:
a second slave electronic device, comprising:
a second input port coupled to the second output port for receiving the first slave address and the second port code transmitted from the second output port; and
a second address calculating unit, calculating a second slave address according to the first slave address and the second port code for determining the second slave address as an address of the second slave electronic device.

18. The master-slave electronic system according to claim 17, wherein, the first slave electronic device further comprises a third output port and a third port code related to the third output port, and the master-slave electronic system further comprises:
a third slave electronic device, comprising:
a third input port coupled to the third input port for receiving the first slave address and the third port code transmitted from the third input port; and
a third address calculating unit, calculating a third slave address according to the first slave address and the third port code for determining the third slave address as an address of the third slave electronic device.

19. The master-slave electronic system according to claim 18, wherein, when the master electronic device transmits a first command comprising a first address signal and a first data signal to the first, the second and the third slave electronic devices, the first, the second and the third slave electronic devices determine whether to process the first data signal and make corresponding response according to a comparison between the first address signal and the addresses of the first, the second and the third slave electronic devices, respectively.

20. The master-slave electronic system according to claim 18, wherein, when the master electronic device transmits a second command comprising a universal address signal and a second data signal to the first, the second and the third slave electronic devices, all of the first, the second and the third slave electronic devices process the second data signal and make corresponding response.

21. The master-slave electronic system according to claim 16, wherein the master address comprises a master layer bit and a master port address bit and the first slave address calculated by the first address calculating unit comprises a first layer bit and a first port address bit, the first layer bit equals the master layer bit plus 1 and the first port address bit equals the first port code.

22. The master-slave electronic system according to claim 16, wherein, the first address calculating unit fills the first port code into a first 0-valued bit of the master address to obtain the first slave address.

23. A master-slave electronic system, comprising:
a master electronic device comprising a master address, a first output port and a first port code related to the first output port, the master electronic device calculates a first slave address according to the master address and the first port code; and
a first slave electronic device, comprising:
a first input port coupled to the first output port for receiving the first slave address transmitted from the first output port; and
a first processing unit, setting the first slave address as an address of the first slave electronic device.

24. The master-slave electronic system according to claim 23, wherein, the first slave electronic device further comprises a second output port and a third output port, and the master-slave electronic system further comprises:
a second slave electronic device comprising a second input port coupled to the second output port, the second input port being related to a second port code;
a third slave electronic device comprising a third input port coupled to the third output port, the third input port being related to a third port code;
wherein, the first processing unit calculates a second slave address according to the first slave address and the second port code, and further transmits the second slave address to the second slave electronic device through the second output port, so that the second slave address being as an address of the second slave electronic device, and, the first processing unit calculates a third slave address according to the first slave address and the third port code and further transmits the third slave address to the third slave electronic device through the third output port, so that the third slave address being as an address of the third slave electronic device.

25. The master-slave electronic system according to claim 24, wherein, when the master electronic device transmits a first command comprising a first address signal and a first data signal to the first, the second and the third slave electronic devices, the first, the second and the third slave electronic devices determine whether to process the first data signal and make corresponding response according to a comparison between the first address signal and the addresses of the first, the second and the third slave electronic devices, respectively.

26. The master-slave electronic system according to claim 25, wherein, when the master electronic device transmits a second command comprising a universal address signal and a second data signal to the first, the second and the third slave electronic device, all of the first, the second and the third slave electronic devices process the second data signal and make corresponding response.
